(19) United States
(12) Patent Application Publication
(10) Pub. No.: US 2016/0375293 A1
(43) Pub. Date: Dec. 29, 2016

(54) Aerobic and anaerobic device system for video game platforms.

(71) Applicant: Luke Helis, Riverside, CA (US)

(72) Inventor: Luke Helis, Riverside, CA (US)

(21) Appl. No.: 14/749,673

(22) Filed: Jun. 25, 2015

(51) Int. Cl. A63B 21/02; A63F 13/24; A63B 21/005

(52) U.S. Cl. CPC A63B 21/023; A63B 21/0058; A63F 13/24

(57) ABSTRACT

A system of exercise for video game platforms comprising of a (variable) winding device of an elastic strap that is mounted on an exercise machine connecting to a video game controller. By adding an elastic strap on a video game controller it makes it heavier, but provides balance on an exercise machine. Most exercise machines have adjustable resistance, said winding device adjusts resistance on said video game controller.

### PRIOR ART

Many inventions have been made to quickly adjust length in leashes, cords, measurement tapes, and more using mechanical and or electrical embodiments, the present invention utilizes a variable of mechanical and or electrical embodiments to make a variable of economical winding devices.

### BRIEF DESCRIPTION OF THE EMBODIMENT

An exercise machine comprising a (variable 3 types: semi-manual, semi-automatic, and automatic) winding device of an elastic strap that connects to a video game controller fastener or video game controller mount fastener that produces an exercise system for all video game platforms comprising a video game controller. Said elastic strap can be of any shape so long as it stretches and contracts to its original form (e.g., tubular like a resistance band, or flattened like a ribbon). The semi-manual and semi-automatic winding device are similar to each other as in they both comprise of a retractable spring that winds the reel, while the automatic winding device uses an electric motor to wind the reel.

### DETAILED DESCRIPTION OF THE EMBODIMENT

For the purposes of promoting an understanding of the principles of the invention, reference will now be made to the exemplary embodiment. The embodiment disclosed is not intended to be exhaustive or limit the invention to the precise form disclosed in the following detailed description. Rather, the embodiment is chosen and described so that others skilled in the art may utilize its teachings. It will be understood that no limitation of the scope of the invention is thereby intended.

A semi-manually controlled winding device for exercise machines: a case comprising a reel with a hollow core of a retraction spring cavity and a retraction spring, implementing at least one elastic strap in alignment as to wind. Said case further comprising a narrow gap aligned with said elastic strap wherein said elastic strap exits; thereon said case's narrow gap further comprising on its surface a threaded cylinder connecting with a shaft threaded at the end as to connect and go through said threaded cylinder and said case, that inhibits said elastic strap when fastened. Lastly, said shaft, further comprising of signals to let the user know when the resistance tube is locked or unlocked.

A semi-automatic winding device for exercise machines: a case comprising of a reel with a hollow core comprising a retraction spring cavity and a retraction spring, implementing at least one elastic strap fastened to the reel in alignment as to wind. Moreover, Said case further comprising a narrow gap aligned with said elastic strap wherein said elastic strap exits, thereon said case's narrow gap further comprising on its surface an opening and a linear actuator motor or motorized leadscrew fastened to said case (preferably a stepper motor linear actuator) with a blocker fastened (or comprising the size of said narrow gap of said case) on the linear actuator screw. Said linear actuator further comprising leads to the exercise machine circuitry comprising its controls and power supply, or may have its own power supply and or its own device control. To save cost said linear actuator can be driven without an encoder, instead a simple reverse and forward should do as said narrow blocker of the linear actuator will have no place to go once it blocks said elastic strap on said narrow gap of said case, and a cover on top of said linear actuator will prevent the linear actuator screw from reversing any more than required. Thereon, a push button would be most effective in this device as the amount needed to change positions would be done in a flash given the distance the linear actuator screw would have to travel, but a beep can let the user know when to let go of said push button.

An automatic winding device for exercise machines: a case comprising of a reel coupled with a worm drive motor. The speed of the reel should obviously be minimal for safety reasons and with only one speed mode. Moreover, said motorized reel control switch is preferably an off-automatic-manual control switch (also known as a three position switch) preferably with said switch comprising an analog stick used in video game controllers. Said reel further implementing at least one elastic strap. Moreover, Said motor further comprising leads onto the exercise machine circuitry comprising its controls and power supply, or may have its own power supply and or its own device control.

Said elastic strap of said semi-manual, semi-automatic, or automatic winding device further comprising of, a fastener or connection on the top end fastened to a video game controller or a video game mount also comprising a fastener housing, a counterpart of said elastic strap top end fastener. Lastly said case of said semi-manual, semi-automatic, or automatic winding device further comprising of a fastener connection that mounts on the center bottom or mid center of said exercise machine. If the exercise machine doesn't have a fastener connection said case's fastener can comprise of a clamp that mounts on an exercise machine pole or counter (as applicable).

Although the invention has been described in detail with reference to certain preferred embodiments, variations and modifications exist within the spirit and scope of the invention as described and defined in the following claims:

1. An exercise machine further implementing a case of a reel with a hollow core comprising a retraction spring cavity and a retraction spring, moreover implementing at least one resistance tube (or elastic leash) fastened to the reel in alignment as to wind; said case further comprising of a narrow gap aligned with said resistance tube, thereon further comprising a leadscrew going through said case, said leadscrew fastening to a shaft, said shaft leading to the dashboard of the exercise machine implementing a turn handle.

2. The embodiment of claim 1, wherein said leadscrew further comprising a cap or block at the bottom end, or comprising the size of said narrow gap of said case.

3. The embodiment of claim 1, wherein said leadscrew may alternatively comprise of a vertical threaded cylinder on the surface of said case, and no screw, but instead comprising of said shaft that connects with said threaded cylinder and plunges on said resistance tube.

4. An exercise machine comprising a case of a reel with a hollow core comprising a retraction spring cavity and a retraction spring, moreover, implementing at least one resistance tube (or elastic leash) fastened to the reel in alignment as to wind, Moreover said case further comprising a narrow gap aligned with said resistance tube, thereon comprising a linear actuator or motorized leadscrew (preferably a stepper motor linear actuator) imposing as a stopper for said resistance tube, moreover comprising leads to an exercise machine circuitry that powers and comprises an open/closed switch or button/s implemented on the exercise machine dashboard.

5. The embodiment of claim 4, wherein the linear actuator may have its own power source, and leads of said linear actuator instead going to a remote with an open/closed switch, fastened to the exercise machine dashboard.

6. An exercise machine comprising a case comprising of, a self moving reel implemented with a rotary stage, which can comprise a worm drive and or a stepper motor that spins said reel, moreover said reel implementing at least one resistance tube, or leash, or any other like, said motor further comprising leads onto an exercise machine circuitry, and an exercise machine dashboard further comprising, a forward and reverse stick or buttons.

7. The embodiment of claim 6, wherein the rotary stage may have its own power source, and leads of said rotary stage going to a remote control with a forward/reverse stick or buttons, being fastened on an exercise machine dashboard.

8. The embodiment of claim 1, 7, or 9 further comprising of, a video game controller or a video game mount comprising a fastener housing, preferably a bulk shape with a hollow chamber, or a bracket with a closed bottom, said resistance tube further comprising a fastener or connection on the top end, preferably a bulk shape that snaps into said shape with a hollow chamber of said video game controller or video game mount

9. The embodiment of claim 8, wherein said video game controller or said video game mount fastener alternatively implementing a weight handle, wherein said handle comprising weight, by the weight of said handle or added weight of any embodiment that may be a part or fastened to said handle (e.g., cement, iron).
